(19) United States
(12) Patent Application Publication
(10) Pub. No.: US 2004/0068474 A1
(43) Pub. Date: Apr. 8, 2004

(54) System and method for analyzing price data on materials

(76) Inventors: Sheng-Chi Luo, Tu-chen (TW); QiongShuai Chen, Shenzhen (CN); Nong Ji, Shenzhen (CN); GenLan Lee, Shenzhen (CN); Wei Zhang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,511

(22) Filed: Dec. 30, 2002

(30) Foreign Application Priority Data
Oct. 4, 2002 (TW) 91122977

(51) Int. Cl. G06F 17/60

(52) U.S. Cl. 705/400; 705/10

(57) ABSTRACT

A price analyzing system (200) for monitoring price changes of materials purchased by an enterprise. The system is employed in a three-tier structure of client computers (101), an application server (102) and a database server (103). The system includes: an information receiving module (201) for receiving information provided by users, the information including a specified time period; a data retrieving module (202) for retrieving price data corresponding to the time period, the retrieved price data including invoice prices, the invoice prices defining a highest price and a lowest price; a Cartesian graph generating module (203) for generating a time-price Cartesian graph by setting an X-axis based on the time period and setting a Y-axis based on the highest price and the lowest price; and a price displaying module (204) for plotting the retrieved price data in the time-price Cartesian graph. A related price analyzing method is also disclosed.

### BACKGROUND OF THE INVENTION

1. Field of the Invention

The present invention relates to systems and methods for analyzing price data on materials, and particularly to a system and method for monitoring price trends.

2. Background of the Invention

With the development of international open markets, effective price control of raw materials is becoming more and more important for manufacturing enterprises. In order to meet the growing demand for more effective price control, many automated systems and methods have been developed.

For example, U.S. Pat. No. 5,960,407 discloses an automated market price analysis system for estimating price characteristics of a product from classified advertisements. The system comprises a plurality of textual characters, a relevant classified advertisement database, an attribute filter, a filtered classified advertisement database, a price analyzer, and a graphing module. The relevant classified advertisement database stores relevant classified advertisement signals indicative of a subset of the classified advertisements that are directed to the product. The attribute filter receives the relevant classified advertisement signals, and generates numeric value signals according to the relevant classified advertisement signals. The numeric value signals are indicative of prescribed subsets of characters in the subset of the classified advertisements. The filtered classified advertisement database receives the numeric value signals and stores them. The price analyzer receives the numeric value signals from the filtered classified advertisement database, and determines the price characteristics of the product according to the numeric value signals. The price analyzer also generates price characteristic signals in accordance with the determined price characteristics of the product. The graphing module receives the price characteristic signals, and generates graphical display signals that represent the price characteristics of the product.

This automated market price analysis system can illustrate price characteristics of products in classified advertisements. However, a manufacturing enterprise does not necessarily need to know price characteristics of a plethora of products found in classified advertisements. Generally, such enterprise only needs to know price characteristics of products most relevant to its business, such as price characteristics of raw materials and sub-components procured by the enterprise. The enterprise can know price characteristics of such commodities by monitoring price movements relating to the commodities both before and after processing by the enterprise. Consequently, a system and method is needed for analyzing prices of commodities, determining price trends of the commodities, and managing prices of the commodities more efficiently.

### SUMMARY OF THE INVENTION

Accordingly, an object of the present invention is to provide a price analyzing system and method for presenting price trends of a material in a specified time period.

Another object of the present invention is to provide a price analyzing system and method for sending alerts when an invoice price of a material is higher than its projected price.

A further object of the present invention is to provide a price analyzing system and method for recording an invoice price and other price data on a material when the invoice price is higher than a reference price.

In order to accomplish the above-mentioned objects, the present invention provides a price analyzing system for monitoring price changes of materials purchased by an enterprise. Application infrastructure of a communication system incorporating the price analyzing system comprises a three-tier structure of client computers, an application server and a database server. A preferred embodiment of the price analyzing system comprises: an information receiving module for receiving information provided by users, the information comprising a specified time period; a data retrieving module for retrieving price data corresponding to the time period, the retrieved price data comprising invoice prices, the invoice prices defining a highest price and a lowest price; a Cartesian graph generating module for generating a time-price Cartesian graph by setting up an X-axis based on the time period and setting up a Y-axis based on the highest price and the lowest price; and a price displaying module for plotting the retrieved price data in the time-price Cartesian graph.

A preferred embodiment of a price analyzing method of the present invention comprises the steps of: (i) receiving information provided by users, the information comprising a specified time period; (ii) retrieving price data corresponding to the time period, the retrieved price data comprising invoice prices, the invoice prices defining a highest price and a lowest price; (iii) generating a time-price Cartesian graph by setting up an X-axis based on the time period, and setting up a Y-axis based on the highest price and the lowest price; and (iv) plotting the retrieved price data in the time-price Cartesian graph.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of application infrastructure of a communication system incorporating a price analyzing system in accordance with a preferred embodiment of the present invention;

FIG. 2 is a schematic diagram of software infrastructure of the price analyzing system in accordance with the preferred embodiment of the present invention;

FIG. 3 schematically illustrates an exemplary time-price Cartesian graph in accordance with the present invention;

FIG. 4 schematically illustrates a price contrasting tabulation in accordance with the present invention; and

FIG. 5 is a flow chart of analyzing prices in accordance with a preferred embodiment of the present invention.

### DETAILED DESCRIPTION OF PREFERRED EMBODIMENTS OF THE INVENTION

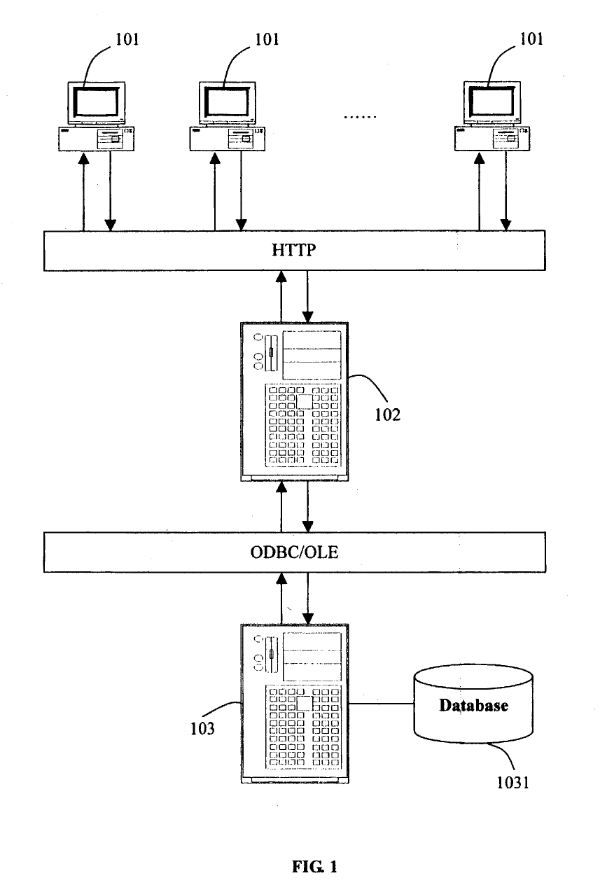

FIG. 1 is a schematic diagram of application infrastructure of a communication system incorporating a price analyzing system in accordance with a preferred embodiment of the present invention. The communication system employs a three-tier information system. The three-tier information system comprises a database server 103 (the bottom tier), an application server 102 (the middle tier), and a plurality of distributed client computers 101 (the top tier). In the preferred embodiment of the present invention, data transfer between the client computers 101 and the application server 102 is by way of Hypertext Transfer Protocol (HTTP). The linkage between the application server 102 and the database server 103 is by Open Database Connectivity (ODBC) or Object Linking and Embedding (OLE).

The database server 103 includes a database 1031, which stores relevant information on an enterprise. In the preferred embodiment of the present invention, the relevant information is mainly price data on materials purchased by the enterprise. Such price data comprise vendor quotations, purchase prices, and invoice prices. The price data are input by relevant departments of the enterprise from the client computers 101, and are then stored in the database 1031. The application server 102 comprises application logic of the enterprise. In the preferred embodiment of the present invention, the application logic includes rules for analyzing and processing of price data on the materials. By means of the client computers 101, users can process price data in the database 1031 through the application server 102.

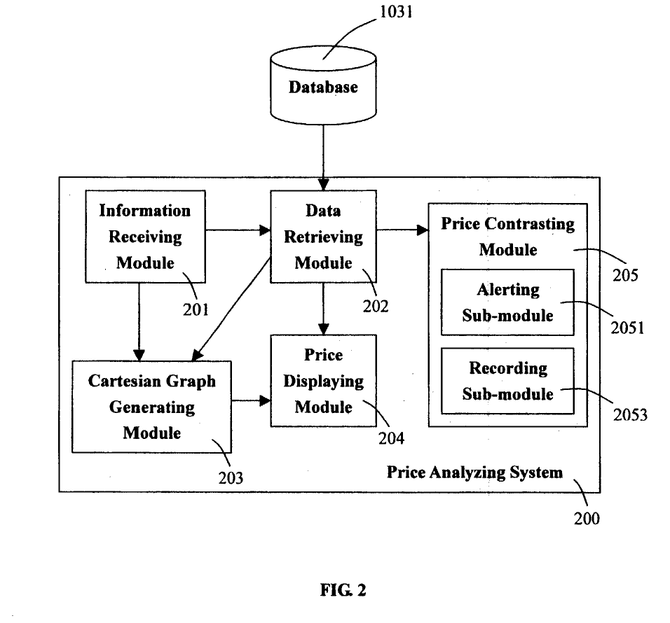

FIG. 2 is a schematic diagram of software infrastructure of a price analyzing system 200 in accordance with a preferred embodiment of the present invention. The price analyzing system 200 is located in the application server 102, and comprises an information receiving module 201, a data retrieving module 202, a Cartesian graph generating module 203, a price displaying module 204, and a price contrasting module 205. The information receiving module 201 is used for receiving information input by users from the client computers 101. The information comprises a name of a material, and a specified time period. The data retrieving module 202 is used for retrieving price data on the material from the database 1031, the price data including a highest price and a lowest price. The Cartesian graph generating module 203 is used for generating a time-price Cartesian graph. This is done by setting up an X-axis based on the time period, and setting up a Y-axis based on the highest price and the lowest price. The price displaying module 204 is used for plotting the retrieved price data to the generated time-price Cartesian graph. The price contrasting module 205 is used for ascertaining differences among the price data on a material, and displaying different price data on a material in a price contrasting tabulation. The price data on a material comprise an invoice price. The price contrasting module 205 comprises an alerting sub-module 2051 and a recording sub-module 2053. The alerting sub-module 2051 is used for alerting relevant managers when an invoice price is higher than other price data on a material. The recording sub-module 2053 is used for recording price data on a material when the invoice price is higher than said other price data on the material, for the purposes of auditing.

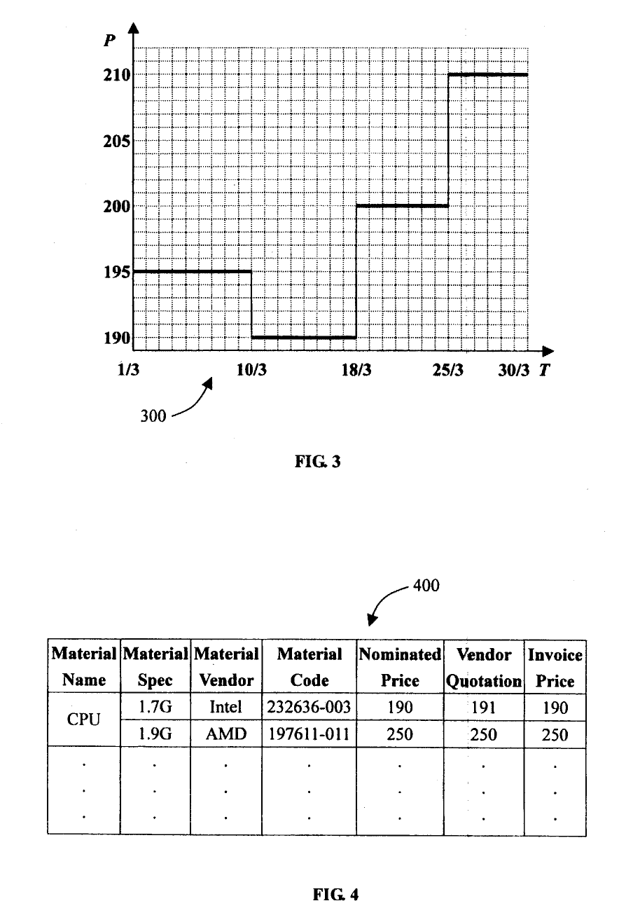

FIG. 3 schematically illustrates an exemplary time-price Cartesian graph 300 in accordance with the present invention. In the preferred embodiment of the present invention, price data changes for a material in a specified time period are illustrated. The material is one kind of central processing unit (CPU), and the time period shown is from March 1st to March 31st. In the time-price Cartesian graph 300, the time axis (X-axis) is divided into thirty-one parts, and the price axis (Y-axis) is divided according to a highest price and a lowest price of the CPU. For example, the CPU has four different prices: 195, 190, 200 and 210 in said time period. The price axis essentially spans from the lowest price (190) to the highest price (210). For the sake of clarity, the origin point of the Y-axis is not at the lowest price, but is a little lower than the lowest price. This avoids superposing a line representing the lowest price on the X-axis itself. In an alternative embodiment of the present invention, the origin point of the Y-axis may be at an average of the highest price and the lowest price. The price data on the material are plotted in the area formed between the X-axis and the Y-axis. The displaying of the price data in the time-price Cartesian graph 300 illustrates a price trend of the material.

FIG. 4 schematically illustrates a price contrasting tabulation 400 in accordance with the present invention. The price contrasting tabulation 400 includes a material name, a material specification, a material vendor, a material code, a nominated price, a vendor quotation, and an invoice price. The nominated price relates to a purchase price of an article that is to be incorporated into a product produced by an original equipment manufacturer (OEM). The purchase price of the article is nominated by a buyer of the product. For example, the OEM produces one kind of computer enclosure for the buyer. The buyer wants the OEM to assemble one kind of power supply into the computer enclosure. The OEM needs to purchase the power supply from a supplier. The buyer can nominate a price for the power supply. The OEM has to purchase the power supply according to the nominated price. Using the price contrasting tabulation 400, a user can easily ascertain differences between price data on a material. The user can also easily compare nominated price data for various materials, and invoice price data for various materials. As shown in the price contrasting tabulation 400, a nominated price of a 1.7G CPU by Intel is 190. A supplier quotation for the CPU is 191. The eventual invoice price of the CPU is 190, for reasons such as negotiation. If the invoice price of the CPU is higher than other prices such as the nominated price, then overhead costs of the OEM would be higher than anticipated. In this case, the alerting sub-module 2051 informs relevant managers, and the recording sub-module 2053 records the price data on the material. The price contrasting tabulation 400 may also comprise other prices, such as a purchase price of the material when purchased by the supplier.

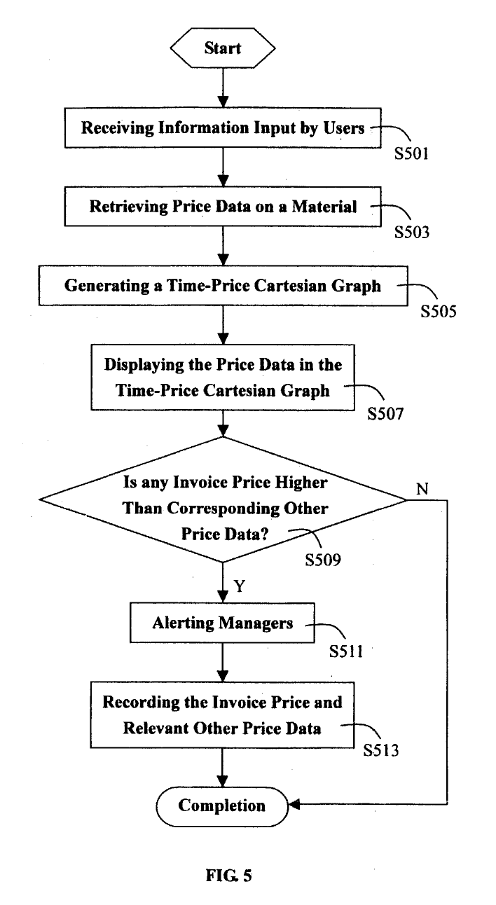

FIG. 5 is a flow chart of analyzing prices in accordance with a preferred embodiment of the present invention. At step S501, the information receiving module 201 receives information input by users from the client computers 101. In the preferred embodiment of the present invention, it is assumed that the input information comprises the material name “CPU” and the time period “2001.3.1˜2001.3.31.” At step S503, the data retrieving module 202 retrieves price data on the CPU for the time period 2001.3.1˜2001.3.31. The price data comprise price changes of the CPU in the time period. For example, on March 1 st the price of the CPU is “195,” on March 10th the price is “190,” on March 18th the price is “200,” and on March 25th the price is “210.” At step S505, the Cartesian graph generating module 203 generates the time-price Cartesian graph 300. This is done by setting up an X-axis based on the time period 2001.3.1˜2001.3.31, and setting up a Y-axis based on the highest price 210 and the lowest price 190. At step S507, the price displaying module 204 plots the price data on the material in the area formed between the X-axis and the Y-axis. The price data thus displayed in the time-price coordinate graph 300 illustrates a price trend of the material.

At step S509, the price contrasting module 205 checks for differences among the price data on the material. In particular, the price contrasting module 205 determines whether any invoice price of the material is higher than other price data. If there are no differences among price data on the material, the procedure of analyzing prices is completed. If any invoice price of the material is higher than corresponding other price data, at step S511, the alerting sub-module 2051 alerts relevant managers via Short Message Service (SMS), E-mail, or other suitable means. At step S513, the recording sub-module 2053 records the invoice price and relevant other price data on the material, for auditing. In an alternative embodiment of the above-described procedure, at step S511, if there is any difference of any kind among the price data on the material, the alerting sub-module 2051 alerts relevant managers via Short Message Service (SMS), E-mail, or other suitable means.

While the present invention has been described above, it should be understood that it has been presented by way of example only and not by way of limitation. Thus the breadth and scope of the present invention should not be limited by the above-described exemplary embodiments, but should be defined only in accordance with the following claims and their equivalents.

What is claimed is:

1. A computer-implemented price analyzing system comprising:
an information receiving module for receiving information provided by users, the information comprising a specified time period;
a data retrieving module for retrieving price data corresponding to the time period, the retrieved price data comprising at least one invoice price, the at least one invoice price defining a highest price and a lowest price;
a graph generating module for generating a time-price graph by setting an X-axis based on the time period and setting a Y-axis based on the highest price and the lowest price; and
a price displaying module for plotting the retrieved price data to the time-price graph.

2. The price analyzing system as claimed in claim 1, further comprising a price contrasting module for ascertaining differences among the retrieved price data.

3. The price analyzing system as claimed in claim 2, wherein the price contrasting module comprises an alerting sub-module for sending an alert to a relevant manager when an invoice price is higher than a reference price datum.

4. The price analyzing system as claimed in claim 2, wherein the price contrasting module comprises a recording sub-module for recording an invoice price and a reference price datum when the invoice price is higher than the reference price datum.

5. A computer-implemented price analyzing method comprising the steps of:
receiving information provided by a user, the information comprising a specified time period;
retrieving price data corresponding to the time period, the retrieved price data comprising at least one invoice price, the at least one invoice price defining a highest price and a lowest price;
generating a time-price graph by setting an X-axis based on the time period and setting a Y-axis based on the highest price and the lowest price; and
plotting and displaying the retrieved price data in the time-price graph.

6. The price analyzing method as claimed in claim 5, further comprising the step of:
ascertaining whether there is any difference among the retrieved price data.

7. The price analyzing method as claimed in claim 6, further comprising the step of:
sending an alert to a manager when the invoice price is higher than a reference price datum.

8. The price analyzing method as claimed in claim 6, further comprising the step of:
recording the invoice price and a reference price datum when the invoice price is higher than the reference price datum.

9. A price analyzing method comprising:
receiving product information input by a user;
retrieving price data on a material making a corresponding product;
generating a time-price Cartesian graph;
displaying said price data in said time-price Cartesian graph; and
informing a manager of any invoice price higher than the corresponding price data within a specific time period.
